(19) United States
(12) Patent Application Publication
(10) Pub. No.: US 2008/0244470 A1
(43) Pub. Date: Oct. 2, 2008

(54) THEME RECORDS DEFINING DESIRED DEVICE CHARACTERISTICS AND METHOD OF SHARING

(75) Inventors: Steven Nowlan, South Barrington, IL (US); Kenneth W. Douros, South Barrington, IL (US); Maria B. Thompson, Hoffman Estates, IL (US); Deborah A. Matteo, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/694,593

(22) Filed: Mar. 30, 2007

(51) Int. Cl. G06F 3/00

(52) U.S. Cl. 715/866

(57) ABSTRACT

An electronic device (130) uses a theme record (120) which defines themes desired for the electronic device. An example patriotic theme might call for red, white and blue screen colors. A processor compares the theme record (120) against at least components (140) of the electronic device to determine operation characteristics of the electronic device (130). The processor can execute a correlation process (133) to resolve conflicts among configurations. The theme records (120) can be shared among users of the portable devices.

### RELATED APPLICATIONS

This application is related to applications being filed concurrently with the USPTO, and assigned to the assignee hereof, identified as: “CONFIGURATION MANAGEMENT OF AN ELECTRONIC DEVICE”, attorney docket number CS27670STARS; and “STAKEHOLDER CERTIFICATES”, attorney docket number CS27780STARS.

### TECHNICAL FIELD

The present inventions relate to electronic devices and systems and, more particularly, relate to customization thereof.

### BACKGROUND OF THE INVENTIONS

Systems have been used for customizing computers and mobile telephones. Typically these systems provided for user level preference settings such as display language, alert settings, service level (such as media bandwidth) and font, within limitations defined by a service provider or the user, or a manufacturer, etc., and combinations thereof.

In addition, systems that allow personalization of a device by downloading components such as ring tones to load onto and customize a device exist and have become popular. These existing systems however allow isolated customizations which are generally not coordinated with each other.

Current electronic devices and portable electronic devices, such as mobile telephones or portable computers, have a large variety of components, features or attributes available for use. These components need to be chosen in some coordinated fashion. What is needed is an advanced system for configuring a device for a theme such as for a particular holiday, band or sports team is proposed.

### BRIEF DESCRIPTION OF THE DRAWINGS

Details of the inventions will be more readily understood from the following detailed description when read in conjunction with the accompanying drawings wherein:

FIG. 1 illustrates a schematic block diagram of a system according to some embodiments of the present inventions;

FIG. 2 illustrates a schematic block diagram of an electronic device according to some embodiments of the present inventions;

FIG. 3 illustrates a schematic block diagram of an exemplary theme table according to some embodiments of the present inventions;

FIG. 4 illustrates a schematic block diagram of an exemplary components database according to some embodiments of the present inventions;

FIG. 5 illustrates a flow diagram of a process for using a theme record to configure the device according to some embodiments of the present inventions;

FIG. 6 illustrates a flow diagram of how themes are obtained and negotiated according to some embodiments of the present inventions; and

FIG. 7 illustrates a flow diagram for interactively asking a device to use a particular theme record according to some embodiments of the present inventions.

### DETAILED DESCRIPTION OF THE PREFERRED EMBODIMENTS

Ring tones and personalization of devices such as cellular telephones have become increasingly popular. Electronic devices and portable electronic devices, such as mobile telephones or portable computers, have various components, features or attributes available for use. These components need to be chosen. What is needed is an advanced system for configuring a device for a theme such as for a particular holiday, band or sports team is proposed. The embodiments of the present inventions provide a system for easy theme selection and configuration.

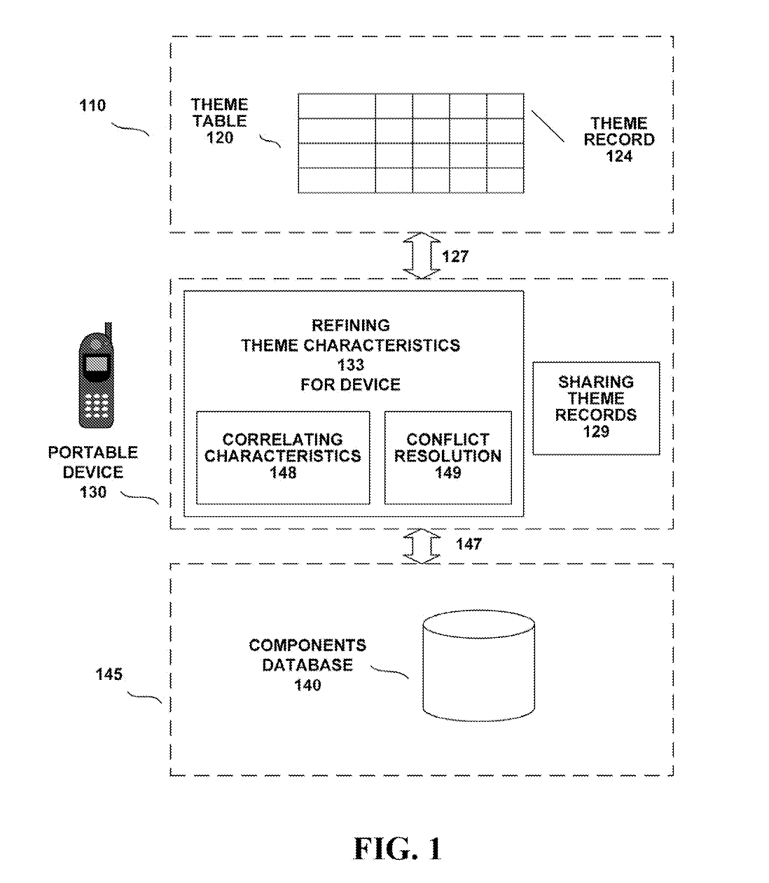

FIG. 1 illustrates a schematic block diagram of a system according to some embodiments of the present inventions. A theme table 120 holds a plurality of themes. Each theme is a candidate for a portable device 130. The theme table 120 is stored in memory 110. A given theme table 120 defines recommended characteristics to be established for various capabilities of a device. These characteristics can be colors desired for the electronic device such as patriotic colors of red white and blue. An electronic device uses one or more themes from the table 120 to configure the electronic device.

The theme table 120 of FIG. 1 contains a plurality of themes 124. Each theme record 124 provides a device such as the portable electronic device 130 of FIG. 1 with information defining desired characteristics for the device. The desired characteristics can be expressed in each theme record with one or more characteristic descriptions.

Theme records 124 can be shared to and from the portable device 130 using a method of sharing the theme records 129. This allows users to share themes among friends. It also allows a user to receive a theme broadcast to them from the proprietor of a venue. Thus, for example, when a user is at a business establishment such as a movie theatre, the device can inherit properties of the movie they are watching, when at a rock concert, the device can inherit the specific rock artist's theme, or when at a Disney theme park, the device can be broadcast and inherit the Disney theme. In order for sharing to occur, the processor of the portable device 130 must understand the theme in the same way it was sent by a friends device or from a venue. This might be accomplished by developing standardized theme representations.

A refinement method 133 chooses characteristics for the device 130 using at least one theme record 124 and the components database 140.

When the processor faces multiple options for a theme 124, the refinement method 133 decides which characteristics to use. This is particularly useful when a device has limited capabilities for implementation of a theme.

The refinement method 133 finds best match components to implement a theme. The refinement method 133 correlates 148 the desired characteristics in the themes 124 with a components database 140. By correlating 148 the desired characteristics for a device with the available components in a device, a configuration is determined for the portable device 130. This correlation gives a theme “wish list” a “reality check” as to the available components on a device.

Records from a capability table 240 indicating desired characteristics of user interface categories for capabilities of the device can also be added to the correlation 148 to further filter or prioritize the configuration choices. Additionally stakeholder requirements can also be added to the correlation 148 to further filter or prioritize the configuration choices and signed certificates may be used to ensure requirements and themes come from trusted sources.

After the correlation 148, any conflicts can be resolved using a conflict resolution process 149. One approach might be using the above-mentioned capability table records or stakeholder priorities. An additional approach of resolving conflicts could be prompting a user of the device. Another could be using the most recent record. Furthermore, the conflict resolution can identify any irresolvable conflicts to the user so that the user can make a selection.

Each portable device 130 is associated with a components database 140. The components database 140 may be stored in memory 145 which can be the memory of the portable device 130, depending on a chosen system configuration. The components database 140 is coupled to the portable device 130 at 147. The components database 140 contains lists of the components available in the portable device 130. The components database 140 also lists, for each component, capabilities of that component. For example, a camera component would have its capabilities define the kinds of images producible by the camera such as mpeg or jpg.

A portable electronic device 130 such as a mobile telephone has its operation characteristics (the values of features, capabilities or attributes used in operation) selected by use of the available themes. The theme table record 120 and the components database 140 may be used. The theme table 120 is coupled to the portable device 130 at 127.

The embodiments of the present inventions provide methods for negotiation of operation characteristics of the electronic device using theme records 124. The refinement method 133 determines operation characteristics of the electronic device by correlating one or more of the themes 124 with the component database 140 for a portable device 130. This allows for implementation of desired themes using the available components of the portable device.

The correlation 148 between the records of the theme table 120 and the components database 140 can be a matching process followed by thresholding. The same matching followed by thresholding can be used on the records of the capability table 240. After the thresholding, conflict resolution 149 can be applied.

An example of one matching process is to take the vector dot product on the rows of the table against the database. This is then followed by thresholding to select the best matching rows that are above a certain threshold. The rows above the threshold are then run through the conflict resolution process 149 and authorized and ranked based on the stakeholder.

In a first embodiment of method 133, a combination of themes and perhaps capabilities is cast as a constrained linear optimization problem. There are a number of well known methods in the literature for solving these types of constrained optimization problems, including linear programming, simplex methods and convex hull methods. Examples can be found in Principles of Operations Research, H. M. Wagner, 1975. In all of these methods, the basic approach is to minimize some measure of dissatisfaction, which is a weighted combination of the degree of dissatisfaction of all of the constraints. The optimization method will proceed until a global minima is found. The general method allows constraints to be defined in terms of continuous ranges of values, but a simplification is to allow each constraint to simply be represented by a binary variable which is 0 if the constraint is satisfied and non-zero otherwise. For this special case, binary programming can be used which is a more efficient form of optimization algorithm.

A second embodiment of method 133 is simpler, but much more efficient to implement, form of conflict resolution. The approach is fairly simple, and can be illustrated by considering a particular example. Imagine that there are three options for implementing a theme or a theme with a capability. If you consider each option as being a filter on allowed values of a variable, then we are combining together these filters as long as they are compatible with each other, until we have the tightest filter possible.

The method 133 can be performed in the portable device 130 or alternatively on a server in its network or system.

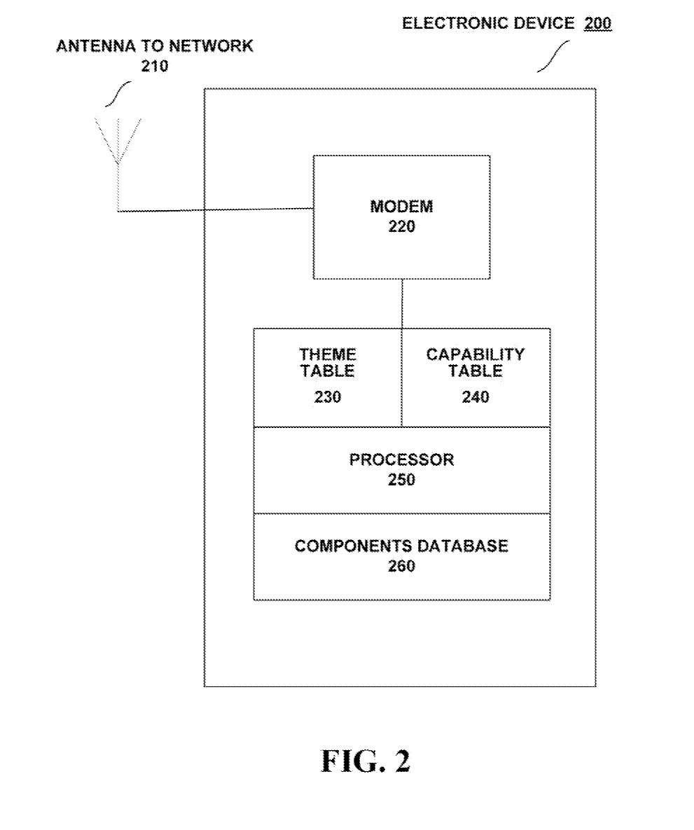

FIG. 2 illustrates a schematic block diagram of an electronic device 200 according to the present inventions. A modem 220 such as a radio transceiver is coupled to an antenna 210. The modem 220 communicates with a processor 250. The modem 220 preferably receives themes over a network. The themes are held in theme table 230 stored in a device memory for the processor 250.

In addition to theme records held in a theme table 230 stored in a device memory, capability table records can also held in capability table 240.

Further, the processor 250 has access to the components database 260 of the electronic device 200. The components database 260 is typically established in the electronic device 200 at the time of its manufacture, but could be downloaded or updated over the modem 220. Also, the theme records in the theme table 230 and the capability table 240 could be established by the electronic device 200 rather than received from the network over the modem.

The processor 250 can share or obtain these records to or from the portable device 130 using a radio modem 220 over a network 210 or via point-to-point local networks such as Bluetooth or using other kinds of modems 220 such as an infra-red modem. This way a user might share themes among friends. The processor of the device can optionally contain digital rights management (DRM) to grant and deny sharing rights according to user, device or time.

The processor 250 can perform a correlation within the electronic device 200 to determine the operation characteristics using one or more themes from the theme table 230 and data from the components database 260. In an alternate implementation, the correlation may use one or more records from the capability table 240 in addition to the one or more themes from the theme table 230 and the data from the components database 260 to determine the operation characteristics for the electronic device 200.

A capability table can contain a plurality of capability table records. Each capability table record provides a device such as the portable electronic device 130 with information defining desired characteristics for the device. The desired characteristics can be expressed in each capability table record with one or more characteristic descriptions, wherein each of the characteristic descriptions defines desired characteristics for a plurality of user interface categories of a plurality of capabilities of a device. A characteristic can define a desired persistence, for example, of an alert or a key press. Ranges can be defined by a desired maximum and minimum range of characteristics for one or more user interface elements. Ranges can specify the size and resolution of the user interface elements. A discrete value can define a desired characteristic for one or more user interface elements. The characteristics can include size, resolution, persistence and location of the user interface elements.

The correlation method in processor 250 can correlate the desired theme from the theme table 230 with a components database 260. The correlation method can alternatively correlate the desired theme together with records from a capability table 240 and data from a components database 260 to determine characteristics for the device. By correlating the desired theme for a device with at least the available components in a device, a configuration is determined for the portable device. This correlation gives the theme “wish list” a “reality check” as to the available components on a device.

Although a radio transceiver and antenna is illustrated for the electronic device 200 of FIG. 2, an antenna is not necessary and a wired network connection can be used instead. Further, the electronic device 200 can be any electronic device such as a laptop, personal digital assistant (PDA), portable gaming unit, camera, multimedia player, set top box or cellular telephone. The electronic device may be one of a cellular telephone, a multimedia player, a portable gaming unit, camera, and a Personal Digital Assistant (PDA).

Although some of the tables may be described above as being stored in the electronic device, the tables can alternatively be stored on a server connected over the network to the electronic device. Furthermore the processor for performing the stakeholder decisions can either access the records over the network or could itself also be located on a server and deliver the decisions over the network to the portable electronic device. Furthermore, the tables can alternatively be stored on another electronic device, which may or may not be portable and which communicates with the first device via wired or wireless means, and the processor for performing stakeholder decisions may also be located on another electronic device (for example a wireless accessory such as a Bluetooth headset could have its properties configured by a cellular phone that it was wirelessly connected to via Bluetooth).

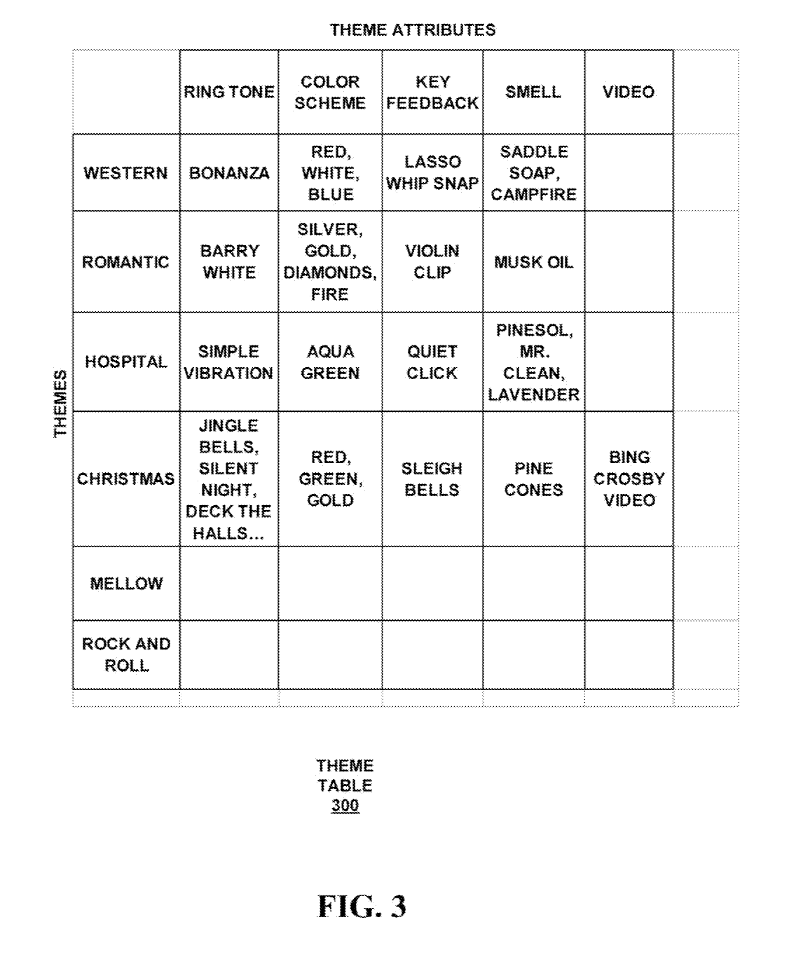

FIG. 3 illustrates a schematic block diagram of an exemplary theme table 300 according to some embodiments of the present inventions. A plurality of themes are contained in a theme table. Each theme provides information defining desired characteristics for a device such as a portable electronic device. The desired theme characteristics can be expressed for each theme with theme attributes and desired characteristics options. For example, a western theme might have a bonanza ring tone and a lasso whip snap key feedback sound. Examples of themes include western, romantic, hospital, Christmas, mellow and rock music or band themes as illustrated along the y-axis of FIG. 3. Other examples of themes are artist, location, sporting event, sports team, holiday and patriotic themes. Examples of theme attributes are ring tone, color scheme, key feedback sound, screen background patterns, aroma and video attributes illustrated along the x-axis of FIG. 3.

At any given time, there may be only one theme for the processor of a device to correlate, or a device will be presented with more than one theme option or even more then one theme to choose to implement. When the processor faces multiple theme choices, the correlation method 133 decides which attributes to use. In one approach, using AND filtering, the correlation method 133 combines themes to find attributes common to the theme options or multiple themes.

The theme table can hold sets of attributes as metadata pertaining to media residing outside of the theme table. A group of themes is called a theme plug-in and comprise one or more theme records. The record of a theme table can be arranged in an industry standard format for sharing and use among devices.

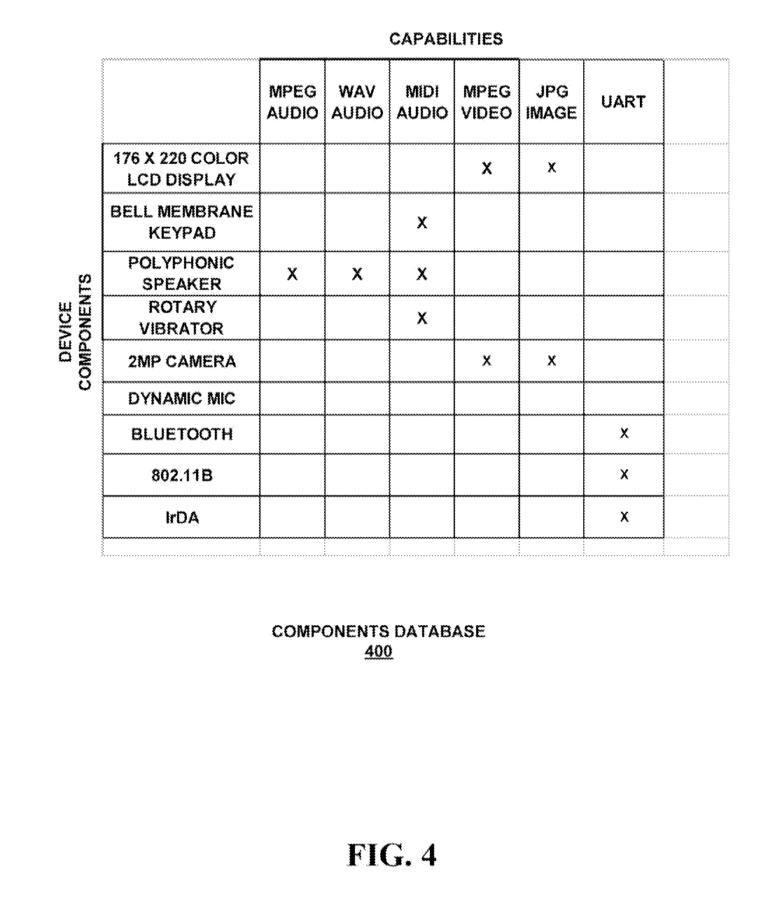

FIG. 4 illustrates a schematic block diagram of an exemplary components database 400 according to the present inventions. The components database defines the capabilities of a given electronic device, based upon an intersection of the components resident in a given device and the capabilities of each component. A camera component, for example, would have its capabilities defined as the kinds of images producible by the camera such as mpeg or jpeg. A display component, for example, would have its capabilities defined as the kinds of images producible by the display, such as jpeg and mpeg images, and also the kinds of audio, such as wav and mpeg audio. A keypad component could have its capabilities defined, for example, as the one or more kinds of audio produced for key click feedback.

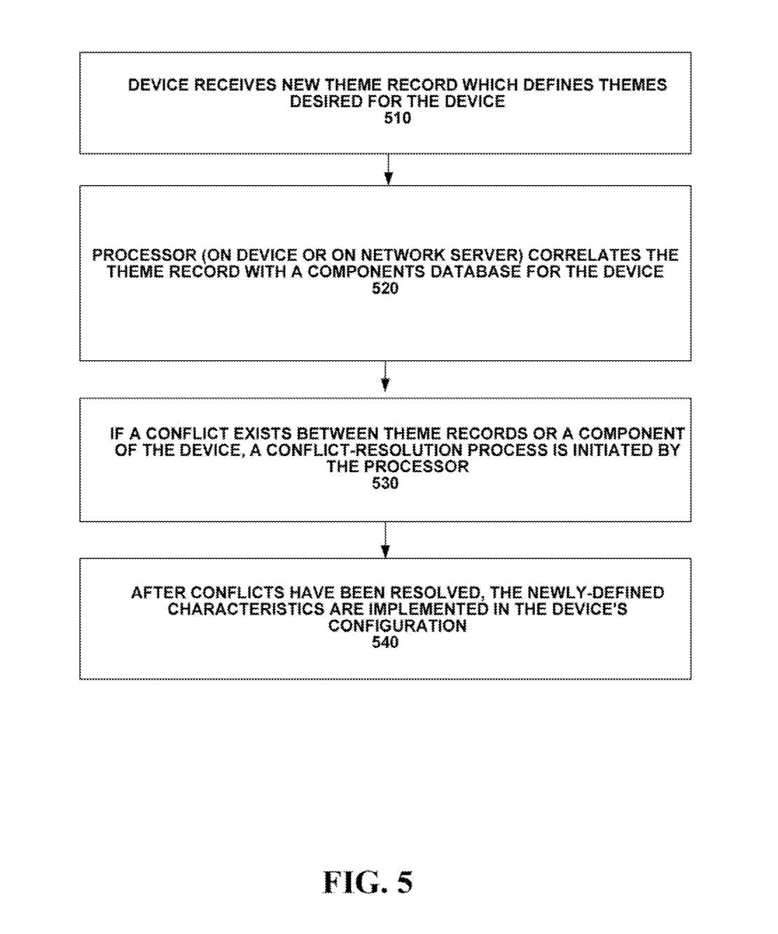

FIG. 5 illustrates a flow diagram of a process for using a theme record to configure the device according to some embodiments of the present inventions. At step 510, the device receives a new theme record defining themes desired for the device. A processor, on the device or on a network server or other device, correlates the theme record with a components database for the device at step 520. The correlation 520 can also use desired capabilities from a capability table to determine the characteristics for the device. If a conflict exists between theme records or a component of the device, a conflict-resolution process is initiated by the processor at step 530. After conflicts have been resolved, the newly-defined characteristics are implemented in the device's configuration at step 540.

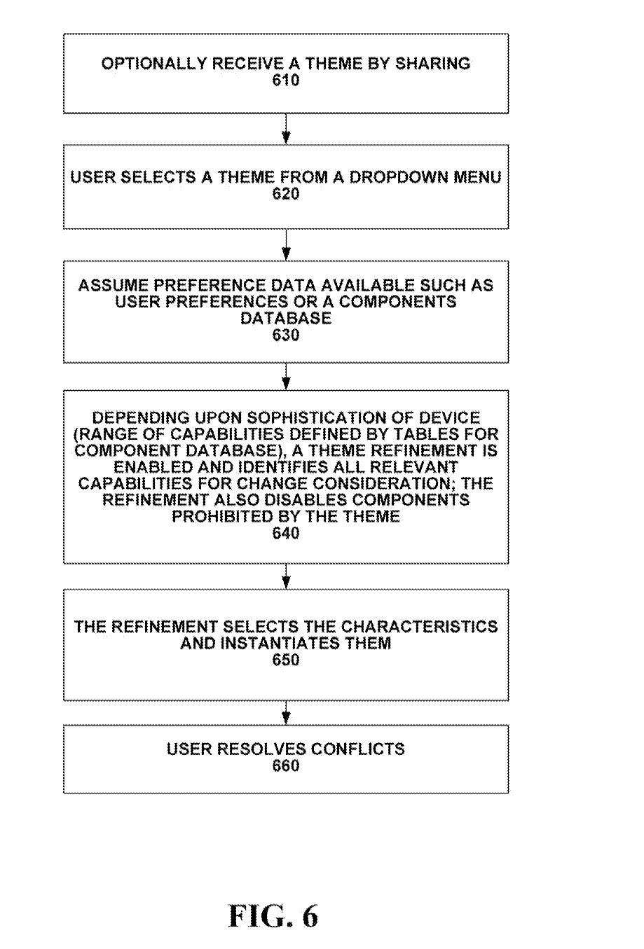

FIG. 6 illustrates a flow diagram of how themes are obtained and negotiated according to some embodiments of the present inventions. A user of a device optionally receives a theme by at step 610. The theme may be received by sharing with another user, from a venue, or by downloading from a theme provider. A user selects a theme from a dropdown menu at step 620. At step 630 it is assumed that preference data is available such as user preferences or records from a components database. Depending upon the sophistication of the device (range of capabilities defined by tables for a component database), a theme refinement is enabled and identifies all relevant capabilities for change consideration; the theme refinement also disables components prohibited by the theme at step 640. The theme refinement can be implemented as a heuristic algorithm and performs the basic steps of correlating capabilities with the theme and resolving conflicts. The theme refinement selects the characteristics and instantiates them at step 650. Optionally, the user resolves any remaining conflicts at step 660.

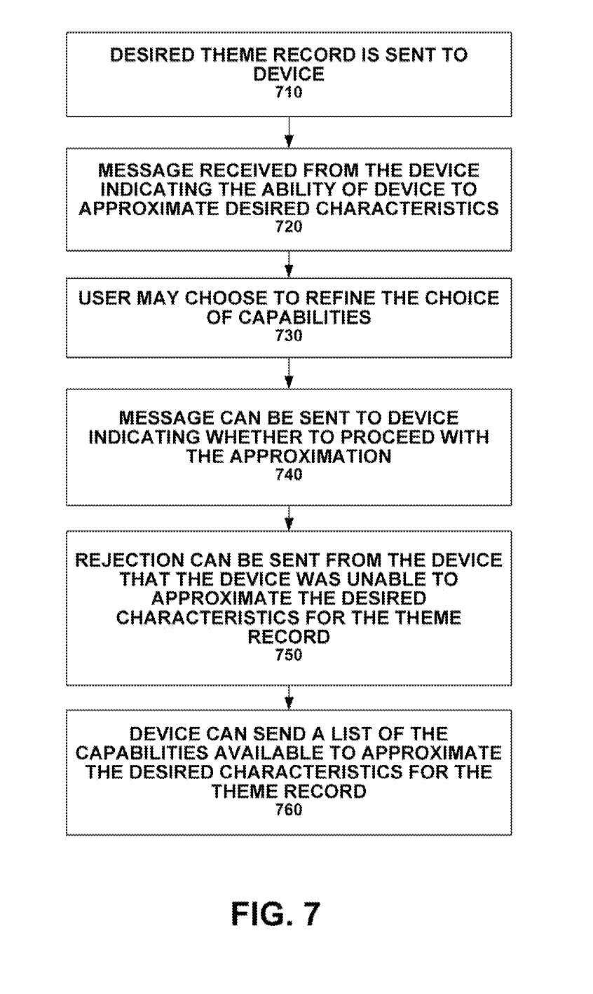

FIG. 7 illustrates a flow diagram for interactively asking a device to use a particular theme record according to some embodiments of the present inventions. This allows a venue or theme provider to have a server interactively ask a device to adopt a theme and obtain feedback from the device. In step 710 a desired theme record is sent to the device. The sent theme record can indicate what characteristics are desired so that the device can realize the characteristics defined in the theme record according to capabilities of the device as close as it can achieve. In step 720, a message is received from the device indicating the ability of the device to approximate the desired characteristics. These capabilities of the device can include hardware and software user interface capabilities of the device. The message received in step 720 can define the degree of ability of the device to approximate the desired characteristics for the theme record. At step 730, the user may choose to refine the choice of capabilities. At step 740, after message receiving step 720, a message can be sent to the device indicative of whether or not to proceed with the approximation for the theme record. At step 750 a rejection can be sent from the device that the device was unable to approximate the desired characteristics for the theme record. At step 760, the device can send a list of the capabilities available to approximate the desired characteristics for the theme record.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. A theme record defining themes desired for a device, the record comprising a plurality of theme attribute descriptions, wherein each of the theme attribute descriptions define desired properties for one or more user interface elements that are consistent with the theme.

2. A theme record according to claim 1, wherein a theme is chosen from the group consisting of western, romantic, hospital, mellow music, rock and roll music, artist, location, sporting event, sports team, holiday, and patriotic themes.

3. A theme record according to claim 1, wherein each of the theme attribute descriptions defines desired properties for one or more user interface elements.

4. A theme record according to claim 1, wherein each theme attribute description specifies one or more attribute choices.

5. A theme record according to claim 1, wherein the theme attributes are chosen from the group consisting of ring tone color scheme, key feedback sound, screen background patterns, aroma and video attributes.

6. A theme record according to claim 1, wherein a theme record includes digital rights management data to grant and deny sharing rights.

7. A theme record according to claim 6, wherein the digital rights management of a theme record includes data to grant and deny sharing rights according to user, device and time.

8. A theme record according to claim 1, wherein the characteristics define both capabilities and constraints.

9. A theme record according to claim 1, wherein desired characteristics of a device comprise modalities and size, resolution, and duration and location within the device.

10. A theme record according to claim 9, wherein the size is indicative of persistence of an alert or a key press.

11. A theme record according to claim 9, wherein resolution is indicative of the sampling rate of audio.

12. A theme record according to claim 9, wherein resolution is indicative of the pixel density of an image or graphical display element.

13. A theme record according to claim 9, wherein resolution is indicative of key characteristics.

14. A theme record according to claim 1, wherein a theme table holds a plurality of theme records.

15. A theme record according to claim 1, wherein a theme record holds a set of characteristics as metadata concerning data residing outside of the record.

16. A theme record according to claim 1, wherein a plug-in comprises one or more of said theme records.

17. A theme record according to claim 1, wherein the theme record is in an industry standard format for sharing and use among user devices.

18. An electronic device capable of using a theme record defining characteristics desired for the electronic device, said electronic device comprising:
a memory for storing the theme record, wherein the record includes characteristics desired for the device to implement a theme; and
a processor operatively coupled to the memory for refining the theme record against the capabilities of the electronic device to determine operation characteristics for the electronic device.

19. An electronic device according to claim 18, wherein the processor refines by first correlating the operation characteristics with the theme record and second applying conflict resolution.

20. An electronic device according to claim 19, wherein the conflict resolution applied by the processor identifies any irresolvable conflicts to the user.

21. An electronic device according to claim 18, wherein the device further comprises a modem operatively coupled to the memory for connecting a theme record with an entity outside of the device.

22. An electronic device according to claim 21, wherein modem comprises at least two of a cellular radio modem, a Bluetooth modem and an infrared modem.

23. An electronic device according to claim 21, wherein the processor of the electronic device includes a digital rights management function to evaluate digital rights management data in a theme record and to grant and deny sharing rights.

24. An electronic device according to claim 21, wherein the modem shares a theme record with another device.

25. An electronic device according to claim 21, wherein the modem receives a theme record from a proximate venue, wherein said theme so received is indicative of the proximate venue.

26. A method of interactively asking a device to use a particular theme record, comprising the steps of:
sending a desired theme record to a device, the theme record indicating what characteristics are desired so that the device can realize the characteristics defined in the theme record according to capabilities of the device as close as it can achieve; and
receiving a message from the device indicating the ability of the device to approximate the desired characteristics.

27. A method according to claim 26, wherein the capabilities of the device include hardware and software user interface capabilities of the device.

28. A method according to claim 26, wherein the message received in said step (b) defines the degree of ability of the device to approximate the desired characteristics for the theme record.

29. A method according to claim 26, wherein said step (b) further comprises the substep of (b1) sending a rejection that the device was unable to approximate the desired characteristics for the theme record.

30. A method according to claim 26, wherein said step (b) further comprises the substep of (b1) receiving from the device a list of the capabilities available to approximate the desired characteristics for the theme record.

31. A method according to claim 26, further comprising the step of (c) allowing a user to choose to refine the choice of capabilities.

32. A method according to claim 26, further comprising the step of (c) subsequent to the receiving a message from the device in said step (b), sending a message to the device indicative of whether or not to proceed with the approximation for the theme record.

33. A method according to claim 26, further comprising step (c) of sending theme records to share among devices.
